(19) United States
(12) Patent Application Publication
(10) Pub. No.: US 2010/0001034 A1
(43) Pub. Date: Jan. 7, 2010

(54) LOADING DEVICE OF A PNEUMATIC NAIL GUN

(76) Inventor: CHUN-MING HUANG, TAICHUNG HSIEN (TW)

Correspondence Address: Chien-Hui Su, P. O. Box 70-121 Taichung, Taichung City, 40899, TW

(21) Appl. No.: 12/168,162

(22) Filed: Jul. 7, 2008

(51) Int. Cl. B27F 7/00

(52) U.S. Cl. 227/120

(57) ABSTRACT

The present invention relates to a loading device of a pneumatic nail gun that has two corresponding receptacles possessed on the connection device and the magazine base. Two grooves are implemented inside the receptacles and two pivots are implemented on both sides of the magazine with two flanges provided on the two pivots. Through the match of the pivots and the flanges with the receptacles and grooves, a user can rotate the magazine having it positioned slantwise so that the loading port of the magazine will be changed in position from firth on the handle to slantwise, then unlock the fixing ridge on the barrel to load nails into the magazine.

### BACKGROUND OF THE INVENTION

1. Field of the Invention

The present invention relates to a loading device, and more particularly to a loading device of a pneumatic nail gun that has its both sides pivotally positioned and axially eccentric to its central axis, through that the magazine loading port can be quickly turned out eccentrically and the objective of easy loading would be attained.

2. Description of Related Art

As per general acknowledgement to the structure of loading mechanism of magazine of a coiler nailer, a conventional coil nailer has its magazine fixed at the locations of handle and trigger that makes the operation of nails loading not easy. It is necessary to slant the nailer in a certain degree to load nails, therefore some designs of improvement on the mechanism of magazine of coil nailer have been raised in prior patent applications, which are:

Examples of prior applications described as follows:

An improvement on relevant mechanism of magazine of a coil nailer that has the magazine installed at a central shaft which is located in the center of a seat for coil nails, in which a hollow space is provided and a limit barricade is provided on top of the hollow space, two positioning groove are provided symmetrically on the central shaft positioning along the axial direction of the central shaft; the positioning groove includes an axially positioned groove and several transverse positioning grooves which are provided on the two sides of the axially positioned grooves in a manner of up-down staggered steps; other relevant improvement that were granted with patent and indeed have the magazine of the coil nailer improved yet still have shortcomings to be further improved as follows:

1. Not easy to load in nails: in point of view of structure, the improved coil nailer depicted above has its magazine fixed in the front of the handle, it is necessary to slant the nailer in a certain degree to load nails into the magazine smoothly, which is so sophisticated to get nails loaded.

2. Not easy to operate: is point of view of operation, the improved coil nailer has an overweight magazine cover such that it is not easy for a user to grip the handle firmly during the opening and closing of the magazine cover, to load nails in is not easy and smooth as well, which does not meet the requirement of practically and convenience in operation.

The present invention has arisen to mitigate and/or obviate the disadvantages of the conventional coil nailer.

### SUMMARY OF THE INVENTION

The main objective of the present invention is to provide an improved loading device of a pneumatic nail gun, which is presumed to have nails being loaded quickly, more conveniently and safely, and the objectives of easy operation and safe locking are attained as well.

To achieve the objective, the nail gun with the loading device in accordance with the present invention comprises two corresponding receptacles possessed on the connection device and the magazine base. Two grooves are implemented inside the receptacles and two pivots are implemented on both sides of the magazine with two flanges provided on the two pivots. Through the match of the pivots and the flanges with the receptacles and grooves, a user can rotate the magazine having it positioned slantwise so that the loading port of the magazine will be changed in position from firth on the handle to slantwise, then unlock the fixing ridge on the barrel to load nails into the magazine.

Further benefits and advantages of the present invention will become apparent after a careful reading of the detailed description with appropriate reference to the accompanying drawings.

### BRIEF DESCRIPTION OF THE DRAWINGS

FIG. 1 is a side schematic view of a loading device of a pneumatic nail gun in accordance with the present invention;

FIG. 2 is an exploded perspective view of a loading device of a pneumatic nail gun in accordance with the present invention;

FIG. 3 is a perspective schematic view of the loading device of the present invention from another side;

FIG. 4 is a perspective schematic view of the loading device of the present invention when the magazine is opened;

FIG. 5 is a bottom schematic view of the loading device of the present invention; and

FIG. 6 is a bottom schematic view of the loading device of the present invention when the magazine is opened.

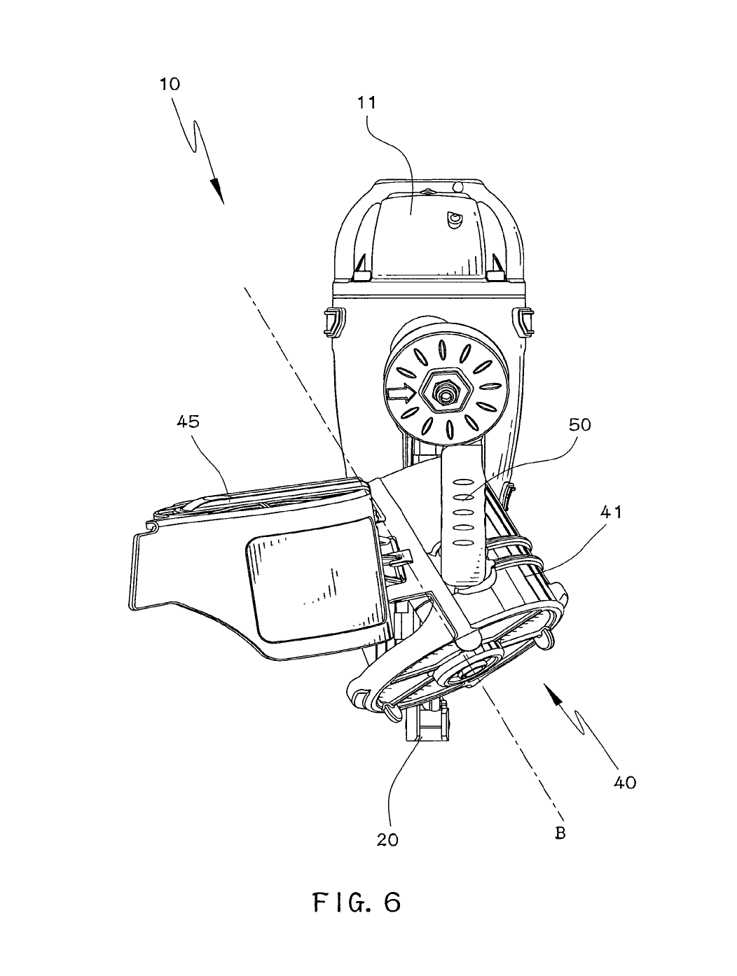

### DETAILED DESCRIPTION OF THE INVENTION

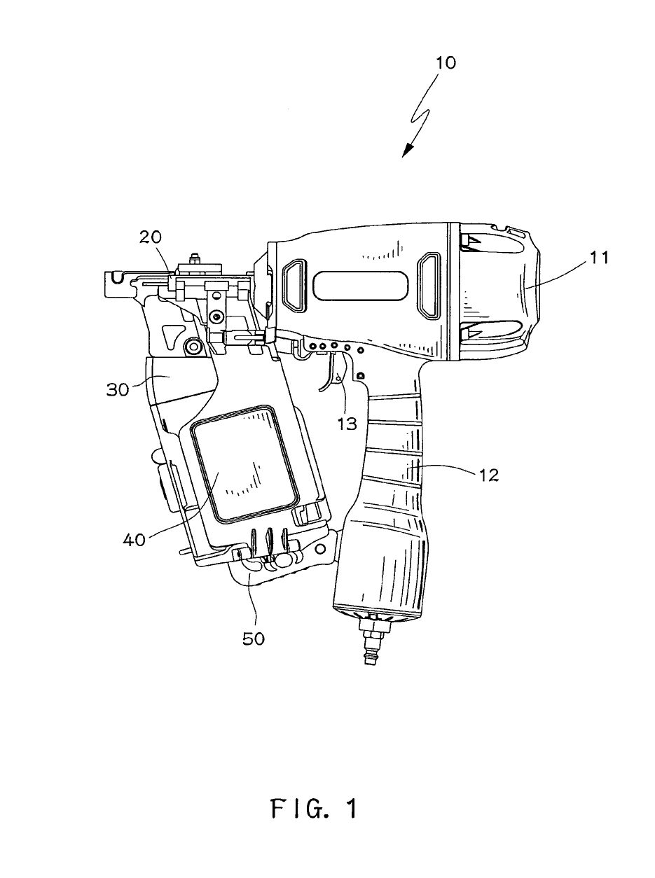

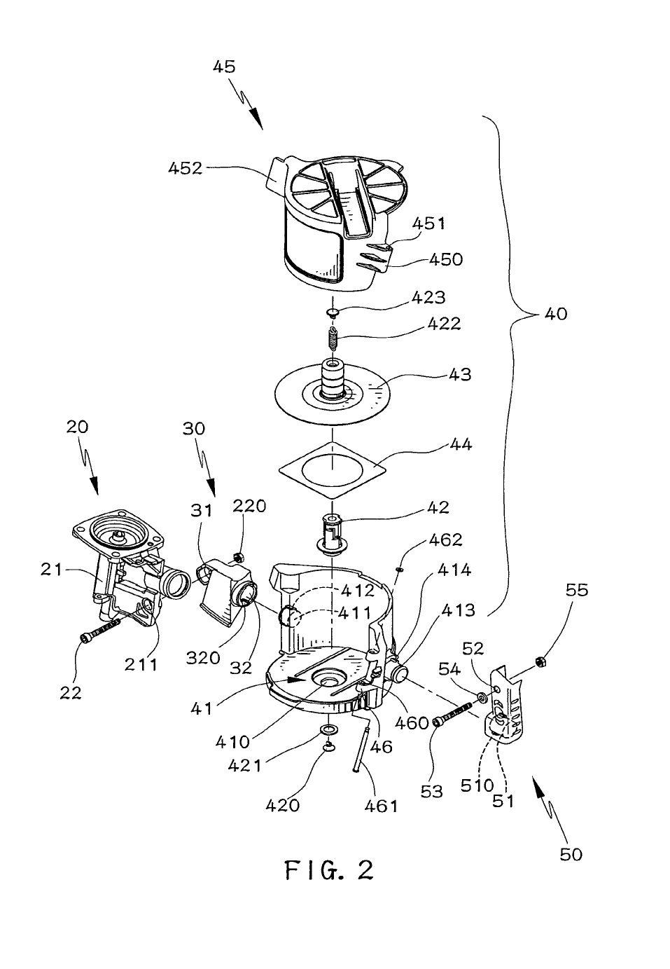

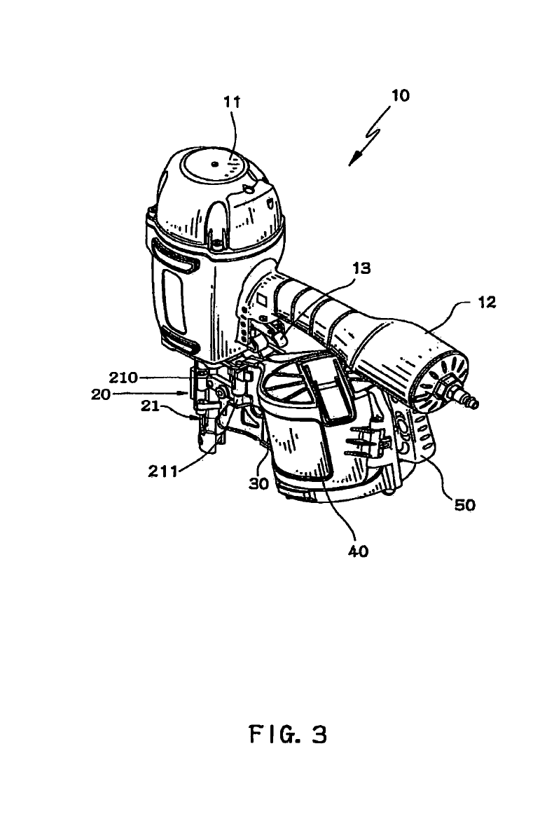

Referring to the drawings and initially to FIGS. 1-3, a loading device in accordance with the present invention is coupled to a pneumatic nail gun 10 that includes a body 11, a handle 12, a trigger 13 and a nosepiece 20. The pneumatic nail gun 10 is equipped with the body that is connected to the handle 12, and the trigger 13 is installed on the body 11 near the handle 12. The nosepiece 20 is coupled to the body. The nosepiece 20 is equipped with a cylinder of barrel 21. A lid 210 is implemented on one side of the barrel 21, and a lock hole 211 is implemented on one side of the lid 210 to lock the lid on the nosepiece 20 to complete the operation of nailing.

The loading device in accordance with the present invention comprises a connection device 30 engaged to the nosepiece 20 with a bolt 22 and a nut 220, a magazine 40 pivotally mounted to the connection device 30 and a magazine base 50 respectively connected to the handle 12 of the nail gun and pivotally mounted to the magazine 40.

The connection device 30 has a connection hole 31 laterally defined therein for connecting to the nosepiece 20 on one end and allowing the bolt 22 extending through the connection device 30, and a first receptacle 32 defined in a shape of hollow cylinder on the other end. The receptacle 32 has at least one first groove 320 defined in an inner periphery thereof. In the preferred embodiment of the present invention, the first receptacle 32 has two first grooves 320 that diametrically correspond to each other.

The magazine 40 is pivotally mounted to the first receptacle 32 of the connection device 30. The magazine 40 has a nail canister 41 defined therein and including a disk and an arc plate vertically extending from a half circumference of the disk. The nail canister 41 has a first pivot 411 and a second pivot 413 respectively extending from two ends of the arc plate thereof. The first pivot 411 and the second pivot 413 symmetrically correspond to each other and each has at least one flange 412, 414 outwardly extending therefrom. The at least one flange 412 of the first pivot 411 is movably received in the at least one first groove 320 such that the rotating range of the magazine 40 is limited. In the preferred embodiment of the present invention, there are two flanges 413 diametrically extending from the first pivot 411. A penetration 410 is provided on the center of the disk. A hollow positioning shaft 42 penetrates through the penetration 410 and is fixed on the nail canister 41 with a first screw 420 and a washer 421, a spring 422 has two opposite ends respectively connected with the first screw 420 and a second screw 423. The positioning shaft 42 is elastic and able to adjust the nail holding plate 43 up and down due to a length of nails in the magazine. The nail holding plate 43 is in shape of disk with extrusion in the center. A gasket 44 is positioned under the nail holding plate 43 and the positioning shaft 42. The magazine 40 includes a magazine cover 45 pivotally connected to the nail canister 41 to defined a space for receiving nails and having a roller 450 with first fixing holes 451 defined therein. A hinge 46 is formed beside the second pivot 413 of the magazine 40. The hinge 46 has second fixing holes 460 defined therein on two opposite ends. The hinge 46 and the roller 450 are fastened together by a pin 461 and a split ring 462. A fixing ridge 452 is formed on the magazine cover 45 opposite the roller 450. When the magazine is closed on the nail canister 41, the fixing ridge 452 is positioned between the nosepiece 20 and the barrel 21, the lid 210 will be locked on the nosepiece 20 helping the mechanism being closed firmly and locked in position.

The magazine base 50 is shaped as an L, wherein one end of the L-shaped has a second receptacle 51 with at least one second groove 510 defined inside, and the other end has a fastening hole 52. In the preferred embodiment of the present invention, there are two second grooves 510 defined in the inner periphery of the second receptacle 51 and diametrically corresponding to each other. The second receptacle 51 linearly corresponds to the first receptacle 32 in the connection device 30. A threaded bolt 53 is gone through a washer 54 and engaged the magazine base 50 and the handle 12 with a nut 55. The second pivot 413 is rotatably received in the second receptacle 51 and the at least one flange 414 is movably received in the at least one second groove 510 such that the rotating range of the magazine 40 is limited.

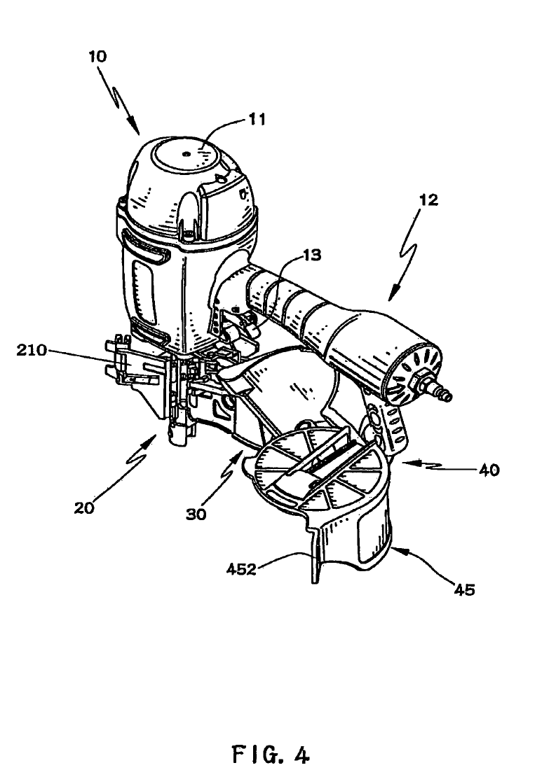

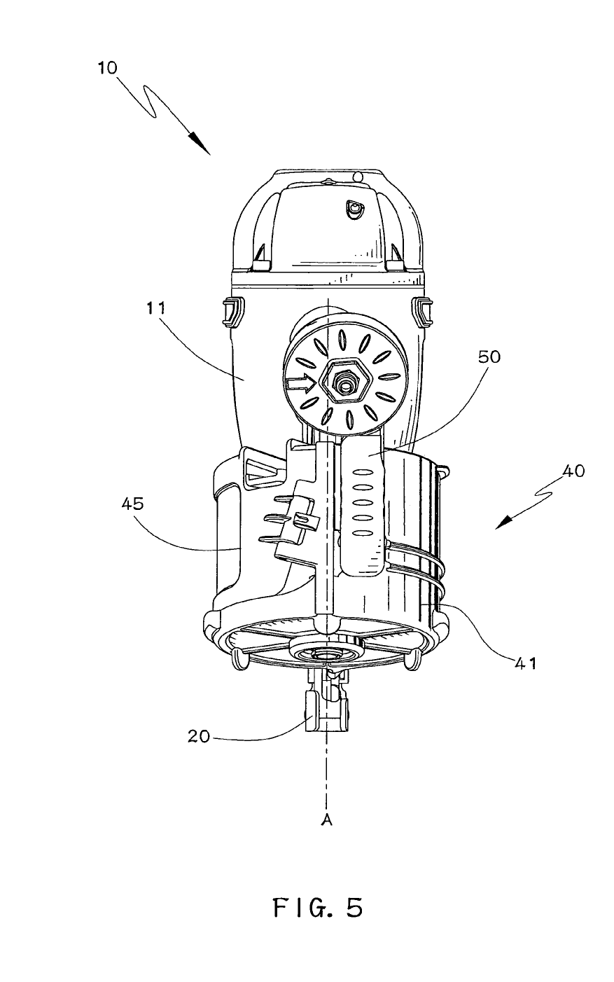

With reference to FIGS. 4 and 5, the loading device in accordance with the present invention includes the connection device 30 adapted to be couple with the nosepiece 20 of the nail gun. The connection device 30 has the connecting hole 31 for connecting to the nosepiece 20 on one side, and the first receptacle 32 in a shape of hollow cylinder on the other side. The first receptacle 32 has the groove 320 inside. The first pivot 411 of the magazine 40 is pivoted to the first receptacle 32, and the second pivot 413 of the magazine 40 is pivoted to the second receptacle 51 of the magazine base 50. When the magazine cover 45 is closed on the nail canister 41, the fixing ridge 452 is positioned right between the nosepiece 20 and the barrel 21, the lid 210 will be locked on the nosepiece 20 helping the mechanism being closed firmly and locked in position, as shown in FIG. 4. Additionally, the magazine 40 would be turned by means of the pivots 411, 413 being pivoted to the receptacle 32, 51, and constrained by the cooperation of flanges 412, 414 and the grooves 320, 510, so that the magazine 40 would be slanted in position on one side of the handle 12, unlock the fixing ridge 452 to load nails into the nail canister 41. After loading, the magazine cover 45 is closed back on the nail canister 41, the fixing ridge 452 is positioned right between the nosepiece 20 and the barrel 21, the lid 210 will be locked on the nosepiece 20 helping the mechanism being closed firmly and locked in position.

With implementation of the structure described above, the functions as follows would be derived:

1. Easy to operate: with the pivots 411, 413 being pivoted to the receptacles 21 51, and constrained by the cooperation of flanges 412, 414 and the grooves 320, 510, so that the magazine 40 would be slanted in position on one side of the handle 12. A user just needs to turn the magazine 40 outwardly, than the magazine cover 45 can be opened to load in nail. It is efficient and easy to operate.

2. Accurate and firm loading: with the pivots 411, 413 being pivoted to the receptacles 32, 51, and constrained by the cooperation of flanges 412, 414 and the grooves 320, 510, so that the magazine 40 would be slant in position on one side of the handle 12. The magazine cover 45 can be opened to load in nails firmly. After loading, closing the magazine cover 45 back to the magazine 40 and push the magazine 40 back to the handle 12, and then the nailing can be operated firmly.

Although the invention has been explained in relation to its preferred embodiment, it is to be understood that many other possible modifications and variations can be made without departing from the spirit and scope of the invention as hereinafter claimed.

What is claimed is:

1. A loading device of a pneumatic nail gun, comprising:
a connection device adapted to be mounted on a underside of a nosepiece of the pneumatic nail gun, the connection device including a first receptacle defined therein and at least one first groove defined in a an inner periphery of the first receptacle;
a magazine base adapted to be laterally mounted to a handle of the pneumatic nail gun, the magazine base including a second receptacle defined therein and at least one second groove defined in an inner periphery of the second receptacle in the magazine base, the second receptacle in the magazine base linearly corresponding to the first receptacle in the connection device; and
a magazine pivotally connected to the connection device and the magazine base, the magazine including a nail canister and pivotally connected to the connection device and the magazine base, and a magazine cover pivotally connected to the nail canister to define a space adapted for receiving coiled nails, the magazine including a first pivot and a second pivot respectively extending therefrom, each of the first pivot and the second pivot having at least one flange laterally extending therefrom, the first pivot rotatably received in first receptacle and the at least one flange of the first pivot movably received in the at least one first groove, the second pivot rotatably received in second receptacle and the at least one flange of the second pivot movably received in the at least one second groove such that the rotating range of the magazine is limited during loading.

2. The loading device as claimed in claim 1, wherein the nail canister includes a disk and an arc plate vertically extending from a half circumference of the disk, the first pivot and the second pivot respectively extending from two opposite ends of the arc plate.

3. The loading device as claimed in claim 2, wherein the magazine includes positioning shaft secured on the disk after extending through the disk into the canister and a nail holding plate in shape with an extrusion in the center, the extrusion sleeved on the positioning shaft, a spring compressively mounted between the positioning shaft and the nail holding plate such that the nail holding plate is moved relative to the positioning shaft due to a length of nails received in the magazine.

4. The loading device as claimed in claim 1, wherein the magazine cover is formed with a roller having first fixing holes defined therein and the nail canister is formed with a hinge beside the second pivot, the hinge having second fixing holes defined therein one two opposite ends, the hinge and the roller pivotally fastened together by a pin that extends the first fixing holes and the second fixing holes, a split mounted to a free end of the pin to prevent the pin from detaching from the magazine.

5. The loading device as claimed in claim 2, wherein the magazine cover is formed with a roller having first fixing holes defined therein and the nail canister is formed with a hinge beside the second pivot, the hinge having second fixing holes defined therein one two opposite ends, the hinge and the roller pivotally fastened together by a pin that extends the first fixing holes and the second fixing holes, a split mounted to a free end of the pin to prevent the pin from detaching from the magazine.

6. The loading device as claimed in claim 3, wherein the magazine cover is formed with a roller having first fixing holes defined therein and the nail canister is formed with a hinge beside the second pivot, the hinge having second fixing holes defined therein one two opposite ends, the hinge and the roller pivotally fastened together by a pin that extends the first fixing holes and the second fixing holes, a split mounted to a free end of the pin to prevent the pin from detaching from the magazine.
